(19) United States
(12) Patent Application Publication
(10) Pub. No.: US 2025/0058254 A1
(43) Pub. Date: Feb. 20, 2025

(54) FILTER ELEMENT

(71) Applicant: Robert Bosch GmbH, Stuttgart (DE)

(72) Inventors: Jose Luis Arias Arias, Madrid (ES); Jan Semet, Vordersteinenberg (DE); Javier Fernandez Garcia, Getafe (ES); Ruben Schreiber, Ludwigsburg (DE)

(21) Appl. No.: 18/721,532

(22) PCT Filed: Dec. 19, 2022
(86) PCT No.: PCT/EP2022/086664

§ 371 Date: Jun. 18, 2024

(30) Foreign Application Priority Data
Dec. 20, 2021 (DE) 10 2021 214 648.1

(51) Int. Cl. B01D 29/15; B01D 35/02

(52) U.S. Cl. CPC B01D 29/15; B01D 35/02; B01D 2201/295; B01D 2201/302; B01D 2201/304

(57) ABSTRACT

The invention relates to a filter element (I) for filtering a liquid and for a flow of the liquid from an unfiltered side (50) to a clean side (52). The filter element (I) has a first end cap (2), a second end cap (3), and a filter medium (4) with a hollow interior (5). The filter medium (4) is arranged between the first end cap (2) and the second end cap (2) along an axial direction (A) wherein the first end cap (2) has a first opening (6) for a flow of the liquid, and a grip guard (7) is arranged in the first opening (6), said grip guard being configured to prevent a finger from penetrating into the interior (5) through the first opening (6).

### BACKGROUND

The invention relates to a filter element for filtering a liquid. The invention also relates to a liquid filter having such a filter element.

Filter elements and liquid filters configured to filter a liquid are known from the prior art. For example, such liquid filters or filter elements are liquid filters or filter elements for filtering a urea solution used in SCR (Selective Catalytic Reduction) systems for exhaust gas purification. Such liquid filters or filter elements are also known as DENOX filters or as filter elements for DENOX filters. In order to avoid damage to a housing of the liquid filter by liquid freezing at low temperatures, for example significantly below the freezing point of water, due to liquid freezing inside it and the resulting ice pressure, what is referred to as a compensation element is often provided in such liquid filters or in such filter elements. This compensation element is, e.g., inserted into the interior of a filter element arranged in the liquid filter. The filter element typically has a first end cap, a second end cap and a filter medium with a hollow interior. The filter medium is arranged between the first end cap and the second end cap along an axial direction. The compensation element, which is made of an elastic material and/or has a hollow interior, for example, is inserted into the interior of the filter element through an insertion opening, which is arranged in one of the two end caps, for example, when the filter element or the liquid filter is installed.

A liquid filter of this kind comprising such a filter element is known from DE 10 2012 223 028 A1.

### SUMMARY

It has been shown that, when the filter element is changed regularly for maintenance purposes (for example after one to three years or when a certain differential pressure is reached), the inside of the filter medium of the new filter to be used is sometimes contaminated.

This is often due to the fact that, when inserting a new compensation element (or even the previously used compensation element) into the new filter element, an installer will reach into the inside of the filter element with their finger, e.g. through the opening opposite the insertion opening for the compensation element. For example, if the compensation element is pushed through an opening in the second end cap into the interior of the filter medium, then installers will often try to better align the compensation element in the interior. This is done by the installer reaching into the interior with a finger or a plurality of fingers through the first opening in the first end cap and then aligning or otherwise manipulating the free end of the compensation element. If the fingers of the installer or their gloves are dirty and/or oily due to previous work, this dirt will reach the inside of the filter medium in the interior. This is undesirable because inhomogeneities in the heat distribution occur when heating the filter element or the liquid filter to thaw frozen liquid (e.g., aqueous urea solution) or gelled liquid (e.g., diesel or gasoline) or to prevent freezing as a result of dirt and/or oil film deposited in the interior at the contaminated locations. This may undesirably delay the thawing process, make it inhomogeneous, require increased heating power, and also reduce the service life of the filter medium. Moreover, the clean side of the filter element is often located in the interior. Dirt or an oily film deposited in this location can then enter the exhaust gas purification system unfiltered in an undesirable manner. It has further been shown that the manufacture of end caps is laborious for such filter elements. These end caps are, e.g., made of plastic by injection molding. If the caps then have a first opening that is approximately centrally located in the end cap, it may be necessary to provide a plurality of injection points in the injection molding process in order to prevent the end cap from being distorted or bent. Particularly in the case of plastics filled with glass fibers with a unidirectional alignment of the glass fibers, a warping of the end caps may occur when manufacturing such end caps by means of a single injection point. In contrast, an injection mold with multiple injection points is comparatively more complex and costlier than one with only a single injection point. It has also been shown that, the greater the volume of liquid in the filter element, the greater the amount of heating energy required to thaw or keep the liquid in the filter element liquid.

There may therefore be a need to provide an end cap for such filter elements that is simple and inexpensive to manufacture and that has a low risk of warping or distortion after the manufacturing process. Furthermore, there may be a need to provide such a filter element which allows a high flow during operation and which is effectively protected from contamination of the inside or the interior of the filter medium during assembly in order to avoid inhomogeneities in the heat distribution during heating, to utilize the heating energy used as efficiently as possible and to prevent contamination from being discharged into downstream components.

According to a first aspect of the invention, a filter element for filtering a liquid is proposed. The filter element can, e.g., be configured or designed to filter the liquid.

The filter element can flow from an unclean side to a clean side of liquid or it is a filter element for a liquid flow from an unclean side to a clean side.

The filter element has a first end cap, a second end cap, and a filter medium having a hollow interior. The filter medium is arranged along an axial direction viewed between the first end cap and the second end cap. The first cap has a first opening for liquid to flow through. The first opening can, e.g., be centrally arranged in the first end cap. According to the present invention, it is proposed that a grip guard is arranged in the first opening, said grip guard being configured to prevent a finger from penetrating the interior through the first opening.

The filter element can, e.g., be configured for use in a DENOX filter or DENOX liquid filter.

The proposed filter element advantageously enables the prevention of contamination of the inside of the filter medium or of the portion of the filter medium facing the interior. Due to the grip guard, an installer can no longer reach into the interior with their fingers, at least through the first opening, when changing the filter element out of the liquid filter and when inserting the new filter element into the liquid filter. Contamination of the filter medium on the side facing the interior is thereby effectively prevented. In this way, an inhomogeneous heating of the interior and/or the filter medium during heating is advantageously prevented. As a result, heating energy can be advantageously saved and the service life of the filter medium can be increased. Furthermore, components downstream of the filter element are effectively protected from contamination. It is further advantageous to prevent individual areas of the filter medium from becoming clogged with oily dirt, for example, so that the effective filtration surface area decreases and the filter element is thus prematurely depleted of its filtration efficiency. Further advantageously, the grip guard reduces the volume available for liquid in the filter element, or the volume available for liquid in the housing of the liquid filter in which the filter element can be arranged. As a result, less heating energy is required when thawing frozen liquids or keeping liquids liquid at low outside temperatures. Advantageously, this enables the use of a smaller heating element, and also reduces fuel consumption (low CO2 footprint). Further advantageously, the volume of the compensation element can also be reduced due to the volume taken up by the grip guard, thereby also reducing the size of the compensation element. Advantageously, this enables lower material usage, therefore making production more cost-effective. This is true because the size or volume of the compensation element is typically adapted to the volume of liquid located in the filter element; this volume is reduced by the grip guard.

A radial direction extends perpendicular to the axial direction. A direction of rotation rotates around the axial direction.

Unless otherwise described, in the context of the present application the term “have” is understood to be synonymous with the term “comprise”.

In one embodiment, it is provided that the interior is configured to receive an elastically reversible and compressible compensation element. As a result, the filter element is advantageously not damaged, even when using liquids that can also freeze under normal operating conditions (e.g., aqueous solutions or water) if the temperature falls below the freezing point of the liquid. Further advantageously, the filter element is able to be constructed in a particularly space-saving manner. The arrangement of the compensation element in the interior (e.g., instead of outside the first or second end cap) enables the filter element to be constructed in a very compact manner and at the same time also reliably protect the interior of the filter medium from damage by ice pressure. At the same time, the grip guard effectively prevents the interior from being contaminated when the compensation element is installed by manipulating the interior with a finger inserted through the first opening, even with such a space-saving arrangement of the compensation element.

In one embodiment, it is provided that the first end cap has an outwardly projecting connecting piece, whereby the connecting piece has the first opening and the grip guard is arranged in the connecting piece.

In this way, it is advantageously achieved that the filter element can be attached to an inlet and/or outlet of the liquid filter in a particularly simple manner by means of the connecting piece because the connecting piece can bridge a distance between the upper and the outwardly-directed end of the first end cap and the inlet or outlet. The arrangement of the grip guard in the connecting piece furthermore increases the distance of the grip guard from the inside of the filter medium. In other words: For example, if an installer succeeds in overcoming the grip guard with part of one of their fingers (e.g., with the tip of a small finger distal to the first finger joint) contact with the inside of the filter medium can still be prevented because the distance between the grip guard and the filter medium is greater than if the grip guard were arranged directly in the plane of the first end cap.

The grip guard can, e.g., be arranged on an end section of the connecting piece facing away from the interior. As a result, the distance that a nevertheless penetrating finger must travel in order to reach the inside of the filter medium is increased in an advantageous manner.

The connecting piece is, e.g., configured to be connected to an inlet or outlet of a liquid filter. As a result, a particularly simple assembly of the filter element on the liquid filter or its inlet or outlet is enabled in an advantageous manner. As a result, the liquid filter structure and the assembly of the filter element in the liquid filter are simplified because a distance between the plane of the end cap and the inlet or outlet can be bridged by means of the connecting piece.

In this context, it is understood that the connecting piece has, e.g., a radius less than a radius of the first end cap. The connecting piece is particularly advantageously designed to be directly adjacent to the first opening in the plane of the first end cap. When viewed from the outside, the opening of the connecting piece represents the first opening. The radius of the connecting piece is advantageously less than 70%, particularly advantageously less than 50% of the radius, of the first end cap.

In one embodiment, it is provided that the connecting piece has a sealing element at a connecting piece outer side or on its connecting piece outer side. As a result, the need for a separate seal of the filter element using a sealing element on an outer side of the first end cap is eliminated in an advantageous manner. Further advantageously, a particularly secure seal between the connecting piece and a flow channel connected thereto (e.g., an inlet and/or outlet for the liquid filter) is thus enabled. The sealing element can, e.g., be designed as a sealing cord and/or O-ring. As a result, a particularly simple and cost-efficient seal is enabled.

In one embodiment, it is provided that the connecting piece protrudes at least 0.5 cm, preferably at least 1 cm, and most preferably at least 1.5 cm beyond a first outer side of the first end cap. For example, the connecting piece can have a length in the range of 1.5 cm to 2.5 cm, for example 1.5 cm. As a result, it is advantageously ensured that a finger or part of a finger penetrating through the connecting piece cannot readily touch the inside of the filter medium. Further advantageously, in case a compensation element is assembled in the filter element, the compensation element can be designed to be longer, thus providing a greater compensation volume. For the free end of such compensation element can be inserted into the connecting piece.

In one embodiment, it is provided that the first opening has a diameter of at least 1.5 cm, preferably at least 2 cm. For example, the diameter is in the range between 1.5 cm and 7 cm, preferably in a range between 1.8 cm and 3 cm. The diameter can, e.g., be 2.3 cm. As a result, a sufficiently high flow rate is always able to flow through the filter element in an advantageous manner. Further advantageously, if a compensation element is inserted into the filter element, its free end can protrude into the connecting piece without impairing the area necessary for the free flow of liquid. As a result, such a compensation element can advantageously have a larger volume.

As a result of the interior being located on the clean side, when the filter element is assembled in the liquid filter, the clean side can be used with as little contamination by dirt or soil as possible, even in a dirty working environment. For the interior does not, e.g., come into contact with dirt, grime, etc. when the filter is placed on the floor or a work surface. This also prevents dirt from dirty hands or gloves from reaching the clean side of the filter element.

In one embodiment, it is provided that the grip guard is designed to be integral with the first end cap. As a result, a particularly simple and inexpensive manufacture of the filter element and/or the first end cap is enabled in an advantageous manner. The term “one-piece” or “integral” is in particular understood to mean that separation of the grip guard and the first end cap is not possible without destroying them. The grip guard and the end cap can, e.g., be designed to be integral with one another. For example, they can be made of the same material.

As a result of the first end cap being designed as an injection molded part, the first end cap and the filter element can be manufactured particularly easily and cost-effectively. For example, the first end cap can be made of plastic. Said cap can, e.g., be made of a plastic. It can, for example, have or be made of unfilled polypropylene (PP) or polyamide (PA) or hard polyethylene (HDPE (abbreviation for “high density polyethylene”)) or have or be made of a glass fiber-filled plastic, e.g. PE, PA (e.g., PA66), HDPE, etc. These can be thermoplastics and/or thermosetting plastics.

The compensation element can, for example, comprise ethylene propylene diene rubber (EPDM) or hydrogenated acrylonitrile butadiene rubber (HNBR), e.g. for the most part or be made of it. A cover and/or a housing of the liquid filter can be made of PA, PA6, PA66, polyphthalamide (PPA), for example, or be made of these materials (with or without glass fiber filling).

As a result of the grip guard being formed by a plurality of ribs, the grip guard is particularly robust and redundant in an advantageous manner. If, for example, one of the ribs is damaged, at least partial grip protection is still provided. Further advantageously, the grip guard can be manufactured particularly easily and cost-effectively in this way.

In one embodiment, it is provided that the ribs extend outwards from a star point within the first opening in a radial direction perpendicular to the axial direction. Advantageously, the first end cap can as a result be easily produced in a simple manner in an injection molding process with a single injection point and simultaneously counteracts warping of the manufactured first end cap. In this case, the injection point can be in or at one of the ribs or in or on the star point. In this way, the still liquid, e.g. thermoplastic or duroplastic, mass can be distributed approximately symmetrically over the first end cap to be manufactured, starting from this injection point. Warping due asymmetry during injection can be counteracted, even when plastics filled with glass fiber are used as the material for the first end cap. Further advantageously, an injection molding process can also be performed in this way using a material that remains liquid for a relatively short time. For the injection point can be arranged very centrally and, in this way, the entire injection mold can be filled in a shorter time (with a single injection point) than, for example, if the single injection point were arranged at the edge of the first opening. As a result, grip protection is provided, as well as significantly simplifying and improving the manufacture and quality of the first end cap.

The ribs can be connected to an inner wall of the first opening, e.g., starting from the star point.

It is understood that the ribs need not necessarily be connected to the inner wall of the first opening. For example, they can also end on an end face of the connecting piece or on the (outward facing) top face of the first end cap or on an underside of the first end cap facing the interior. These possible guides of the ribs starting from the star point are merely by way of example. Further guides for the ribs are also conceivable.

In one embodiment, it is provided that the ribs have an angle to a radial direction (which is perpendicular to the axial direction), whereby the angle is in a range between 5 degrees and 45 degrees, preferably in a range between 10 degrees and 30 degrees. For example, the angle is between 23 degrees and 26 degrees, e.g. 24.5 degrees. As a result, grip protection is further improved, while at the same maximizing the flowable surface in an advantageous manner. This is true because an installer who wants to insert their finger through the grip guard and into the interior of the filter element must then cover a larger distance along the axial direction, along which their finger comes into contact with the ribs, making it even more difficult for fingers to penetrate. In addition, since the open area (between two ribs) in the projection onto a plane is decisive for the possibility of a finger penetrating, the distance between the ribs can be reduced in the proposed way without reducing the flow cross-section for the liquid. In other words: Given the same size of the first opening, the angled arrangement of the ribs can increase the flow area available in each plane or improve the grip protection effect, without reducing the cross-sectional flow for the liquid. Further advantageously, any potential compensation element mounted in the filter element can in this way be made even larger or longer because it can penetrate into the angled space.

As a result of the maximum distance between adjacent ribs being at most 1.5 cm, preferably at most 1 cm, and most preferably at most 0.75 cm, provides particularly secure grip protection. For example, the distance is 0.85 cm.

According to a second aspect of the invention, a filter element as described hereinabove is proposed for use in a DENOX filter or a DENOX liquid filter.

Advantageously, the DENOX filter or the DENOX liquid filter can as a result be heated particularly well and homogeneously, and it can protect downstream components particularly reliably against exposure to dirt and grime.

According to a further aspect of the invention, a liquid filter is proposed.

The liquid filter has a housing comprising a housing interior, as well as an inlet and an outlet. The liquid filter further comprises a filter element as described hereinabove. The filter element is arranged in the housing.

Advantageously, a particularly safe liquid filter that enables a homogeneous heat flow during heating is enabled as a result, even after maintenance in a dirty environment, while using little heating energy and reliably and safely protecting the downstream components from contamination with dirt and grime.

It is understood that the design of the grip guard in the form of ribs is not an essential feature of the invention. Other grip protection options are quite conceivable. It can also be taken into account that an average finger of an average person has an average maximum length.

### BRIEF DESCRIPTION OF THE DRAWINGS

Further features and advantages of the present invention will be apparent to the skilled person based on the following description of exemplary embodiments with reference to the accompanying drawings, but these are not to be construed as limiting the invention.

Shown are:

FIG. 1: a longitudinal section through a liquid filter comprising a filter element from the prior art;

FIG. 2a: a perspective view of a filter element;

FIG. 2b: an enlarged view of the first end cap of the filter element in FIG. 2a;

FIG. 3: a schematic cross-section through a liquid filter comprising the filter element in FIG. 2a.

### DETAILED DESCRIPTION

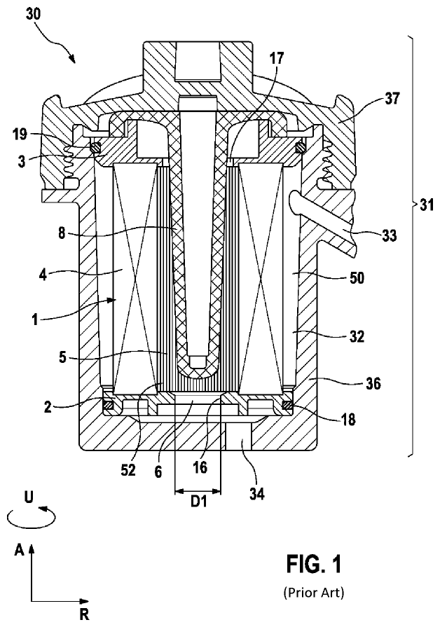

FIG. 1 shows a prior art liquid filter 30 having a housing 31. The housing is composed of a housing cup 36 and cover lid 37 screwed into the housing cup 36. The housing 31 comprises a housing interior 32 as well as an inlet 33 for liquid to be cleaned and an outlet 34 for liquid to be cleaned. The liquid filter 30 further comprises a filter element 1, which is arranged in the housing interior 32. The filter element 1 is configured to filter a liquid. It has a unclean side 50 and a clean side 52. The liquid flows from the unclean side 50 through the filter element 1 to the clean side 52. The filter element 1 comprises a first end cap 2 (in this case at the lower end in the drawing), a second end cap 3 (in this case at the upper end in the drawing) and a filter medium 4 with a hollow interior 5. The filter medium 4 is arranged along an axial direction A viewed between the first end cap 2 and the second end cap 3. The first cap 2 has a first opening 6, which is configured for liquid to flow through. The first opening 6 is arranged centrally in this case, thus around the center point of the filter element, which is, e.g., designed to be circular-cylindrical.

The interior 5 is in this case configured to receive an elastically reversible and compressible compensation element 8. In the drawing shown, the compensation element 8 is arranged in the interior 5 and is fixed between the second end cap 3 and the cover 37 in the liquid filter 30. The second end cap 3 comprises a second opening 17, through which the compensation element 8 is inserted into the interior 5. To seal the clean side 52 from the unclean side 50, a first seal 18 and a second seal 19 are arranged circumferentially around the first end cap 2 and the second end cap 3. When the filter element 1 is installed, the first seal 18 and second seal 19 adjoin a housing inner wall of the housing 31, in this case the housing cup 36.

A radial direction R extends perpendicular to the axial direction A. A circumferential direction U is circumferential about the axial direction A.

When mounting the compensation element 8 through the second opening 17 into the interior 5, an installer can insert their finger through the first opening 6 into the interior 5 in order to, e.g., guide the free end of the compensation element 8 to the correct position for them. In the filter element 1 according to the prior art, the installer can touch the inside of the filter medium 4 and deposit dirt, grime, oil, sweat, or the like there in an undesirable manner.

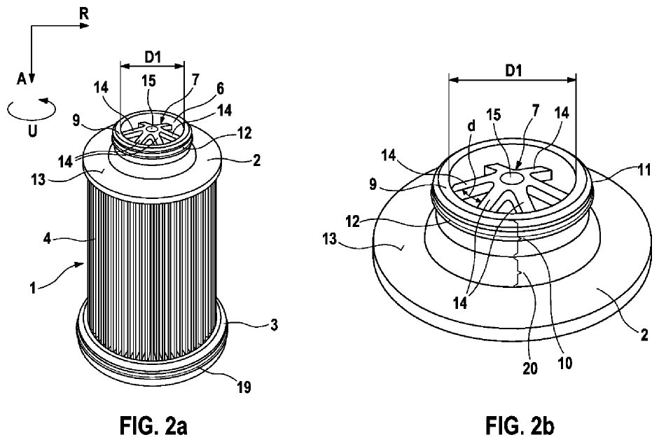

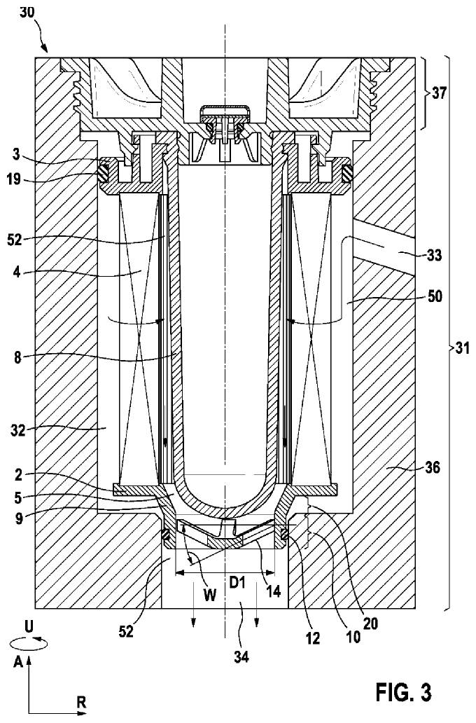

FIG. 2a shows a filter element 1. The filter element 1 has a first end cap 2, a second end cap 3 and a filter medium arranged between the two end caps 2, 3 with a hollow interior 5. The first end cap 2 has a first opening 6. The filter element 1 shown is intended to prevent such contamination of the inside of the filter medium 4. To this end, a grip guard 7 is arranged in the first opening 6 of the first end cap 2, the grip guard 7 being configured to prevent a finger from penetrating into the interior 5 (see FIG. 3) through the first opening 6.

The filter element 1 in this case comprises an exemplary outwardly protruding connecting piece 9, whereby the connecting piece 9 comprises the first opening 6. The grip guard 7 is arranged in the connecting piece 9. The grip guard is arranged on an end section 10 of the connecting piece 9 facing away from the interior 5. Between the first end cap 2 and the end section 10 of the connector 9, the connector 9 is connected to the first end cap 2 by means of a root section 20. For example, the connecting piece is in this case configured to be connected to an inlet 34 of a liquid filter 30. It can also be configured to be connected to an inlet 33 of the liquid filter 30. In the latter case, the interior 5 would be the unclean side 50 of the liquid filter 30. The connecting piece 9 can, e.g., be designed to be one-piece or integral with the first end cap 2.

The connecting piece 9 has a sealing element 12 on one or its outer side 11 which is, e.g., designed as an O-ring. This sealing element 12 can be used to connect the connecting piece 9 to the outlet 34 of the liquid filter 30 in a fluidically sealed manner.

The connecting piece 9 protrudes at least 0.5 cm, preferably by at least 1 cm, in this case for example 1.5 cm, beyond a first outer side 13 of the first end cap 2. The first opening 6 has a diameter D1 of at least 1.5 cm, preferably at least 2 cm. Particularly preferably, the first opening 6 has a diameter D1 of at least 3.5 cm. The diameter D1 can in this case be, e.g., 2.3 cm.

In this exemplary embodiment, the grip guard 7 is formed by a plurality of ribs 14 which extend outwardly from a star point 15 within the first opening 6 in the radial direction R. The ribs 14 are, by way of example, connected to an inner wall 16 of the first opening 6. The inner wall 16 is in this case also an inner wall of the connecting piece 9.

The ribs 14 (as can be seen in FIG. 3) are at an angle W to the radial direction R. The angle W is preferably in a range between 5 degrees and 45 degrees. The angle W is preferably in a range between 10 degrees and 30 degrees. The angle can in this case be, e.g., 24.5 degrees. In this way, the grip guard is further improved and, at the same time, a larger passage area for the liquid can be created in relation to a plane extending in the radial direction R, since for the grip protection 7 in the manner presented herein it is in particular the openings between the ribs 14 projected onto the plane that is important, but for the resistance that is opposed by a liquid, it is the reduction in the cross-section of the first opening 6 that is effectively present in a specific plane.

A maximum distance d between adjacent ribs 14 is at most 1.5 cm in the illustrated exemplary embodiment, preferably at most 1 cm, and more preferably at most 0.75 cm. The distance is in this case, e.g., 0.85 cm.

The grip guard 7 (shown in this case by way of example in the form of a plurality of ribs 14) is designed to be integral with the first end cap 2. It is understood that the connecting piece 9 can also be designed to be integral with the first end cap 2.

The first end cap 2, the connecting piece 9, and the grip guard 7 are designed as injection molded parts in this exemplary embodiment.

The design of the grip guard 7 in the form of ribs 14, which extend radially outwards from a star point 15, also makes it possible to manufacture the first end cap 2 in a particularly simple, safe, and cost-efficient manner. The star point 15, which is in this case arranged, e.g., approximately in the center of the first opening 7 with respect to the radial direction R, can be selected as the injection point. Alternatively or additionally, one or more of the ribs 14 can be selected as the injection point. Preferably, the first end cap 2 can comprise only a single injection point. As a result, a uniform distribution of the liquid injection material is enabled in the injection mold, which is in particular advantageous when using anisotropic injection molding materials, e.g. plastics filled with glass fibers, in order to prevent warping.

It is understood that it is also possible in principle to design the grip guard to have only a single rib 14. The latter can, e.g., extend transversely through the first opening 6. Such a rib 14 can also in principle be considered as two ribs 14 extending away from one another from a star point 15 arranged within the rib 14.

FIG. 3 shows an exemplary liquid filter for a DENOX filter system. However, in contrast to the liquid filter in FIG. 1, the liquid filter in FIG. 2a is mounted here. FIG. 3 clearly shows the angle W between the radial direction R and the ribs 14. It can be clearly seen that the compensation element 8 can be designed longer in this way with the same length of the filter element 1 than in the case of ribs 14 extending parallel to the radial direction R. As a result, the possible compensation volume is increased. It can further be seen that penetration into the interior space 5 of the filter element 1 by a finger is effectively prevented due to the grip guard 7, and also by the length of the connecting piece 9 along the axial direction A.

1. A filter element for filtering a liquid and for a flow of the liquid from an unfiltered side (50) to a clean side (52), said filter element (1) comprising:
a first end cap (2),
a second end cap (3),
a filter medium (4) with a hollow interior (5),
wherein the filter medium (4) is arranged between the first end cap (2) and the second end cap (3) along an axial direction (A),
wherein the first end cap (2) has a first opening (6) for a flow of the liquid,
wherein a grip guard (7) is arranged in the first opening (6), said grip guard being configured to prevent a finger from penetrating the interior (5) through the first opening (6).

2. The filter element according to claim 1,
wherein the interior (5) is configured to receive an elastically reversible and compressible compensation element (8).

3. The filter element according to claim 1,
wherein the first end cap (2) has an outwardly protruding connecting piece (9),
wherein the connecting piece (9) has the first opening (6), and
wherein the grip guard (7) is arranged in the connecting piece (9).

4. The filter element according to claim 3,
wherein the connecting piece (9) has a sealing element (12) on its outer side (11).

5. The filter element according to claim 3,
wherein the connecting piece (9) protrudes at least 0.5 cm or at least 1 cm or at least 1.5 cm beyond a first outer side (13) of the first end cap (2).

6. The filter element according to claim 1,
wherein the first opening (6) has a diameter (D1) of at least 1.5 cm.

7. The filter element according to claim 1,
wherein the interior (5) is located on the clean side (52).

8. The filter element according to claim 1,
wherein the grip guard (7) is integral with the first end cap (2).

9. The filter element according to claim 1,
wherein the first end cap (2) is an injection molded part.

10. The filter element according to claim 1,
wherein the grip guard (7) includes a plurality of ribs (14).

11. The filter element according to claim 10,
wherein the ribs (14) extend outwardly from a star point (15) within the first opening (6) in a radial direction (R) perpendicular to the axial direction (A).

12. The filter element according to claim 10,
Wherein the ribs (14) are at an angle (W) to a radial direction (R) that extends perpendicular to the axial direction (A),
wherein the angle (W) is in a range between 5° and 45°.

13. The filter element according to claim 10,
wherein a maximum distance (d) between adjacent ribs is at most 1 cm.

14. The filter element according to claim 1 for use in a DENOX filter.

15. A liquid filter,
said liquid filter (30) comprising:
a housing (31) having a housing interior (32), as well as an inlet (33) and an outlet (34),
a filter element (1) according to claim 1,
wherein the filter element (1) is arranged in the housing interior (32).

16. The filter element according to claim 1, wherein the connecting piece (9) is configured to be connected to an inlet (33) or outlet (34) of a liquid filter (30), and wherein the grip guard (7) is arranged at an end section (10) of the connecting piece (9) facing away from the interior (5).

17. The filter element according to claim 6, wherein the first opening (6) has a diameter (D1) of at least 2 cm.

18. The filter clement according to claim 11, wherein the ribs (14) are connected to an inner wall (16) of the first opening (6).

19. The filter clement according to claim 12, wherein the angle (W) is in a range between 10° and 30°.

20. The filter element according to claim 13, wherein a maximum distance (d) between adjacent ribs is at most 0.75 cm.
